(19) United States
(12) Patent Application Publication
(10) Pub. No.: US 2003/0149971 A1
(43) Pub. Date: Aug. 7, 2003

(54) Method for transmitting frames with both data and a polling request

(75) Inventors: Robert P. Basil, Lawrenceville, GA (US); Stephane Dennis Jacques Chapeau, Duluth, GA (US); Bradley Richard Ree, Snellville, GA (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: coaXmedia, Inc., Cumming, GA

(21) Appl. No.: 10/357,012

(22) Filed: Feb. 3, 2003

Related U.S. Application Data
(60) Provisional application No. 60/354,095, filed on Feb. 4, 2002.

(51) Int. Cl. H04N 7/16; H04H 9/00

(52) U.S. Cl. 725/16; 725/37

(57) ABSTRACT

A method of using a modified DVB/MPEG2 data frame is disclosed. The method uses a data frame containing both downstream data and Upstream Request (“USR”) channel information in order to efficiently use the downstream frames. The USR channel is used primarily to poll the client modems to identify which modem need to use the upstream channel to transmit an upstream frame. A preferred location for embedding the USR message is within the FEC field, if the FEC field is not being used. Other inventive aspects of this and related concept are developed in the disclosed material. This Abstract is meant to be an aid to searches and not as a limitation on the scope of the claims.

### CROSS-REFERENCE TO RELATED APPLICATIONS

This application claims priority from co-pending U.S. Provisional Application No. 60/354,095 for Protocol with Downstream Frames Containing Both Data and Upstream Request Channel Communications filed Feb. 4, 2002.

This application provides an alternative solution to that provided in a co-pending application with common assignee. The co-pending U.S. application Ser. No. is 10/205,523 for Methods for Efficiently Detecting and Polling Downstream Modems in a Shared Transmission Media Such as Passive Coax Distribution on a Tree and Branch Network filed Jul. 25, 2002.

Another related co-pending application with common assignee is U.S. Ser. No. 09/908,754 for Priority Packet Transmission System for Telephony, Latency-Sensitive Data, Best Efforts Data and Video Streams in a Shared Transmission Media such as Passive Coax Distribution filed Jul. 19, 2001.

Another related co-pending application is Architecture and Method for Automated Distributed Gain Control for Internet Communications for MDUs and Hotels (U.S. application Ser. No. 09/818,378). The '378 application provides an overview of an early version of the solution offered by common assignee, coaXmedia, Inc. coaXmedia, Inc. has a number of other co-pending applications describing-various improvements and variations to the system set forth in the '378 application.

For the convenience of the reader, various acronyms and other terms used in the field of this invention are defined at the end of the specification in a glossary. Other terms used by the applicant to define the operation of the inventive system are defined throughout the specification. For the convenience of the reader, applicant has added a number of topic headings to make the internal organization of this specification apparent and to facilitate location of certain discussions. These topic headings are merely convenient aids and not limitations on the text found within that particular topic.

### BACKGROUND

1. Technical Field

The present invention adds to the field of data communications. More particularly the invention is one of the ongoing improvements in the area of data communications addressing the use of shared transmission media such as passive coax distribution. The present invention interleaves polling requests with downstream data frames. The advantage is that more downstream data frames are carried per unit of time because the downstream transmission of data frames is not interrupted for the transmission of polling frames. One application of the present invention is in a system deployed on a tree and branch coax distribution system for upstream and downstream data communication between a hub-server and a set of two or more client modems.

2. Problem Addressed

A shared transmission media requires coordination of the many modems so that data is not lost or corrupted by two modems attempting to transmit on the same channel at overlapping times. Solutions to this problem include Token ring, polling, and various forms of collision detection. The present invention improves the efficiency of a system that uses polling.

While the present invention can be applied to many situations that use polling as a means to avoid data collisions from client modems, the invention can be explained in the context of one particular use of the invention. The use chosen to illustrate this invention is the use of legacy tree and branch coax distribution network to provide data in addition to the delivery of cable television signals.

The related applications describe a system that allows the connection of devices such as personal computers to special modems that connect to a legacy tree and branch coax network in a hotel, Multiple Dwelling Units (MDUs), or analogous building. The system described used one frequency range bandwidth in two ranges outside of the range used for cable TV. Thus, the system would have one frequency range for a downstream channel and one frequency range for an upstream channel. As this is a tree and branch network, all communications heading downstream must identify which modem device (or devices) is being addressed since all modem devices will receive the communication. Conversely, the communication from the many individual modem devices to the upstream end of the network must be controlled so that only one modem device is sending an upstream communication at any one time in order to avoid bus contention. The method of control used in the referenced applications is based on polling and response model.

The situation addressed by both the '378 application and the current invention is shown generally in FIG. 1. FIG. 1 can be subdivided into four clusters of components. The first cluster is Cable-TV Headend equipment 10. The second cluster is the Hybrid Fiber-coax (HFC) Distribution Network 20. The third cluster is the premises coax distribution equipment 30 which could exist in either an MDU or an analogous situation such as a hotel. The final cluster is the cluster of equipment in the User's Room 40. Clusters 30 and 40 contain elements of the present invention. In keeping with industry conventions, the Cable-TV Headend and the Internet are the upstream end of FIG. 1 for cable TV and IP data respectively. The television set or computer in the user's room are the downstream points. Upstream data transmissions travel upstream towards the upstream end. Downstream transmissions travel downstream towards the downstream end. Thus, a component on a data path receives a downstream data transmission from its upstream end and an upstream data transmission from its downstream end.

The contents of Cable-TV Headend equipment 10 are described in the referenced '378 application and do not need to be repeated here. In general, a cable TV signal is provided to the HFC Distribution Network 20. Digital communication signals from Internet 15 travel through Cable-TV Headend equipment 10 to the HFC Distribution Network 20. The description of selected elements of the Cable-TV Headend is to provide context for the present invention and does not constitute a limitation or required elements for the present invention.

In cluster 30, the incoming signal from the HFC Distribution Network 20 is carried on Cable 31 to Joiner Device 32. The Joiner Device 32 is connected to the input of TV Channel Amplifier 33. The Output of TV Channel Amplifier 33 is passed to a second Joiner Device 34 and then to set of one or more joiner devices forming the Tree and Branch Distribution Network 50 terminating at a series of TV coax Receptacles (not shown). The technology for tree and branch networks suitable to distribute Cable TV signals is well known to those of skill in the art. Thus, in order to avoid unnecessary clutter, the Tree and Branch Distribution Network 50 is shown with just a few joiner devices and connecting cables rather than the full set of components for a tree and branch network.

Joiner Devices 32 and 34 form a bypass around the TV Channel Amplifier 33. This bypass loop has a Cable Modem 35 (or another device with an Ethernet port) at the upstream end and Data Hub 36 (“hub”) (also called the “server”) at the downstream end of the bypass loop. As described in the '378 application referenced above, the Server 36 is comprised of a number of components shown here as RF Modem 37, Protocol Converter 38, and NIC Unit 39 (for Network Interface). The operation of these components was described in the '378 application and does not need to be repeated here. A coax Tree and Branch Distribution Network 50 connects the Head End 42 of the tree and branch network to a set of splitter devices.

A partial set of splitter devices is shown in FIG. 1 as splitters 52, 54, and 56. Thus, the signal at Head End 42 is present at the input to Client Modem Devices 60, 62, 64, 66, 68, and 70. Output jacks on the client modem devices allow for connection of Televisions (71, 75, 80, 84, 86, and 90), devices such as Personal Computers (72, 81, 87, and 92), and Telephones (74, 77, 78, 82, 85, and 88). Note that two Telephones 77 and 78 are connected to Client Modem Device 62. Each of the two telephones is connected to its own telephone port. As the cable TV signal does not need to be processed within the modem devices, this signal can be taken from an external diplexer positioned upstream of the modem device rather than as shown from an output on the modem device.

The '378 application includes an RF coax transmission system in which all information flowing downstream (from 42 to the Client Modem Devices 60, 62, 64, 66, 68, and 70) is formatted according to DVB/MPEG-2 structure to facilitate multimedia applications.

In order to assist in illustrating the concepts of the present invention, the preferred formats for use in the downstream and upstream transmissions in a particular coaXmedia system are illustrated in FIG. 2. The specifics of the data structure are included for an example and do not represent mandatory aspects of the present invention.

Downstream Transmission Frame and Data Packet

A preferred Downstream Transmission Frame 100 is a 204-byte MPEG/DVB frame. The Downstream Transmission Frame 100 is comprised of: a SYNC Byte 104 (of value 47 hex for frame or packet start identification and B8 hex, i.e. inverted 47 hex for multi-frame identification); followed by two bytes used by MPEG2 for Packet Identification 108 (“PID”); followed by an additional byte reserved for Continuity Count 112; a Payload 116 of 184 bytes; and a FEC Field 120 of 16 bytes. The FEC Field 120 is followed by a SYNC Byte 104 from the next frame (not shown). Note that other sync identifiers could be used in place of the sync byte.

The 13-bit PID field is typically set to all 1's. This indicates a null PID for any MPEG devices monitoring the data stream. A null PID is thought to be stuffing data by MPEG decoders. The Continuity Count 112 simply shows an incrementing count for each packet within a stream of data. Each stream of data has its own unique PID 108.

The FEC field 120 is reserved under the DVB standards to optionally contain Reed-Solomon values or other values used in other types of forward error correction. An example of a DVB standard can be found in European Standard (Telecommunications series) document EN in 300 421 v1.1.2 (1997-08) for “Digital Video Broadcasting (DVB); Framing Structure, Channel Coding and modulation for 11/12 GHz satellite services.”

Any downstream data (whether IP, voice, video, etc.) is placed in one or more Data Sub-packets 130. In this prior art Frame 100, a data sub-packet is carried in the MPEG frame Payload 116. The specific organization of the data-sub packets is not important to this invention but the data sub-packets are generally comprised of a Sub-packet Header 134 and a Sub-packet Payload 136. The sub-packet header contains the address of the target and several control fields. The address used for the target could be the MAC address of the client modem, a sub-portion of the MAC address, a nickname for a client modem, a broadcast group address, or other form of address so that the client modem can recognize which sub-packets are addressed to that client modem. The sub-packet payload contains a CRC Value 140 appended at the end of the Data 138 within the Sub-packet Payload 136.

The downstream packet fits into the DVB framing structure. This is accomplished by always placing the start of a packet immediately following the Continuity Count 112 and indicating a start of packet in the upper bits of the PID field. The downstream packet may be short enough to fit into one frame Payload 116 (184 bytes) or may occupy many. If the packet does not end on a frame boundary, then the remaining portion of the 184-byte frame Payload 116 is packed with null data and thus not used for payload. This empty Segment 142 of payload is wasted and it is desirable to minimize this waste.

Upstream Data Frame and Packet

The Upstream Data Frame 150 is comprised of: Preamble 152, a SYNC Byte 154, and a Data Packet 160. The specifics of the data packet are not important but can be usefully divided into a Data Packet Header 166 and a Data Packet payload 168. The Data Packet Payload 168 is of variable length and contains a CRC Value 140.

The Upstream Data Header 166 contains control fields to communicate the length of the variable payload and to identify the type of transmission. The particular system used by coaXmedia, Inc. uses a polling scheme to grant time slots for the Client Modems (60, 62, 64, 66, 68, and 70) to use the upstream channel for communication to the Server 36. Thus, in this system there is no need to identify the source of the upstream communication with a source address.

Data flow downstream and upstream is concurrent, as both use unique frequencies to transmit their data. For example, the downstream communications from server to client modem may be at a first frequency channel with the upstream data traveling on a second frequency channel.

Normal polling would interrupt the process of sending downstream data to insert a frame with an invitation to a particular client modem to transmit upstream data to indicate that it has data ready for transmission. The polling process is repeated to successively poll each of the client modems before resuming the sequence. The present invention is often used in systems with more than fifty client modems. The use of polling frames to periodically poll each of the client modems reduces the capacity of the system to carry downstream data frames. While this negative impact on downstream capacity can be reduced by giving priority to downstream data communications over polling requests, such a compromise would tend to waste upstream capacity as heavy loading on the downstream channel would lead to delays in polling client modems. Such a solution only moves the problem to the upstream channel.

This process is illustrated in FIG. 3. FIG. 3 represents a sequential series of Downstream Frames 100. The frames in accordance with this data format have a fixed number of bytes allocated to frame Payload 116. Frame 304 has a frame Payload 116 that is primarily a data sub-packet and a wasted Segment 142. Frame 308 conveys a Polling Request 350 that occupies only a small portion of frame Payload 116 thus leaving a large waste segment 350. This is a problem in that a large amount of waste decreases the efficiency of the downstream band.

Frames 312, 316, and 320 are carrying a single large payload across three frame payloads. During the transmission of these three frames it was not possible to send a polling request. Thus, this may lead to gaps in the use of the upstream channel. The problem is more severe if the downstream channel is carrying many payloads that are split across several frames.

Thus, before the development of the present invention, there existed a need for a system and method to reduce the loss in downstream capacity caused by the use of downstream frames to carry polling requests and other related communications to the client-modems. Ideally, such a solution should not induce detrimental delays in sending polling requests to the client modems.

### BRIEF SUMMARY OF DISCLOSURE

This application discloses a polling protocol for server/client systems whereby polling requests and/or other communications for use by the client modem are integrated into downstream data frames rather than sent as separate downstream frames. The integrated requests to the client devices are another communication channel, separate from the downstream channel for data. This second integrated communication channel can be called the Upstream Request Channel (“USR channel”).

### BRIEF DESCRIPTION OF THE DRAWINGS

FIG. 1 illustrates an environment that can employ the present invention.

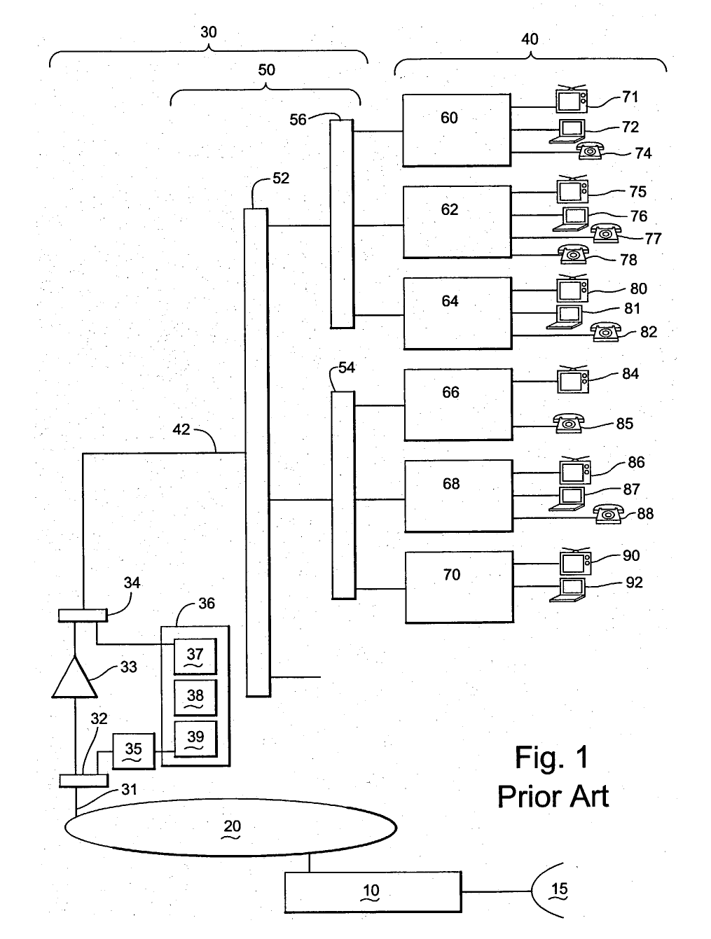

FIG. 2 illustrates a prior art MPEG/DVB Downstream Transmission Frame 100 and a prior art MPEG/DVB Upstream Data Frame 150.

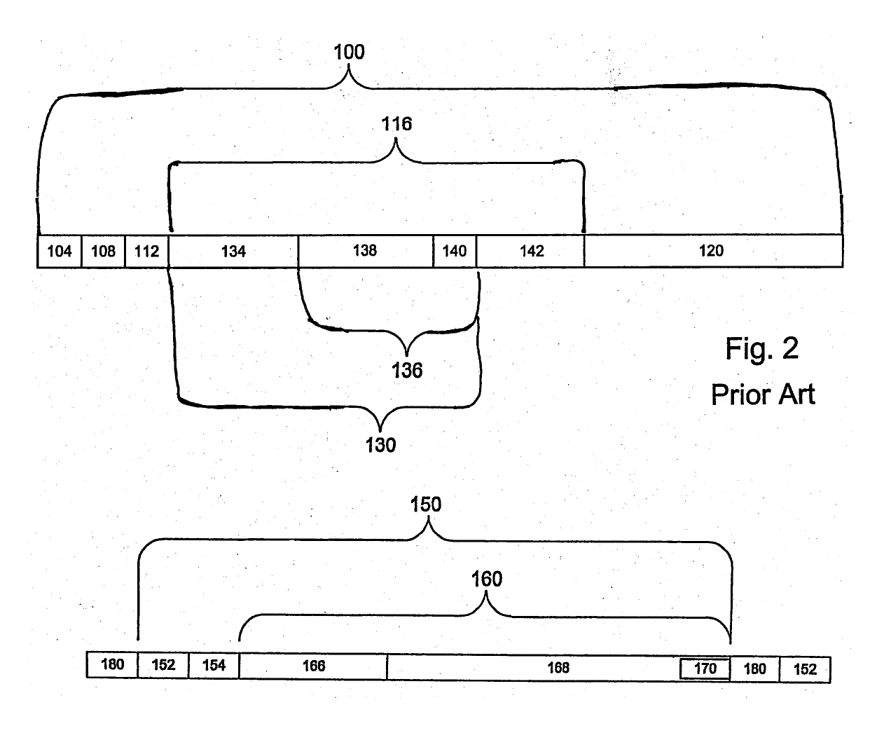

FIG. 3 illustrates the waste in the prior art that comes from sending a Polling Request 350 as the sole use of a downstream frame.

FIG. 4 illustrates a preferred embodiment of the present invention where an Upstream Request Message 200 is placed in a portion of the space originally allocated as a FEC field.

FIG. 5 illustrates an alternative embodiment of the present invention where an Upstream Request Message 200 is placed in the front portion of the space originally allocated as downstream frame payload.

FIG. 6 illustrates an alternative means for adding to the efficiency of downstream frames by sending more than one Data Sub-packet 130 in the data frame Payload 116.

### DETAILED DESCRIPTION OF THE DISCLOSED EMBODIMENT

A client modem with upstream data to transmit must wait for a request to transmit under a polling and response system. Rather than consume downstream frames with the small payload of a request for a client modem to transmit, the present invention teaches the use of the upstream request channel. A small portion of the downstream frame is allocated for use by the USR channel.

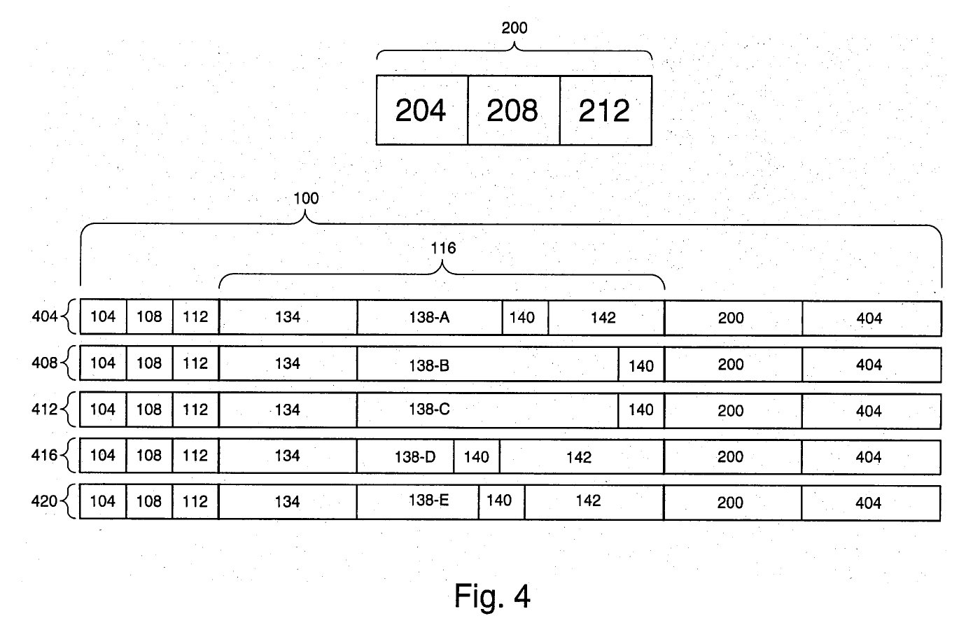

One preferred format for USR messages is shown in FIG. 4. The preferred format of the USR Message 200 starts with a MAC Address 204. In one embodiment, the MAC Address 204 is set to four bytes, but other sizes could be used by one of skill in the art. The MAC Address 204 can be used for a unique modem address, a broadcast address, or a multi-cast address. The preferred format continues with a control field. In the preferred embodiment, this field contains two bytes of various control functions. The next field in the preferred embodiment is a two-byte CRC field 212.

The Upstream Request (“USR”) channel's is used primarily to poll the client modems to identify which client modems need to use the upstream channel to transmit an upstream frame. The USR channel can also be used to send broadcast and multi-cast messages that do not require a response (ex. broadcast reset).

As the Client Modems 60, 62, 64, 66, 68, and 70 recognize the SYNC Byte 104, the USR message can be embedded anywhere in the fixed length downstream DVB/MPEG-2 frame as long as the client modems are adjusted to look for the USR message in a certain span of bytes, a certain offset from the SYNC Byte 104. A preferred location for embedding the USR message is within the 16-byte FEC Field 120, if the FEC Field 120 is not being used.

As shown in the bottom portion of FIG. 4, space in the Frame 100 originally allocated for FEC data has been reallocated to carry a USR Message 200. The Remainder 404 of the FEC field is left unused 404. The eight downstream frames conveyed five frame payloads with data payloads and three polling Requests 350. In contrast, the five downstream frames shown in FIG. 4 convey the same data payloads and convey not three but five polling requests. Part of any communication latency for communication between the Server 36 and the set of fifty or more client modems is the time that a client modem is waiting for a polling request in order to send data upstream. A system that provides for frequent polling of each of the active downstream modems reduces this component of latency. A system made in accordance with the present invention would enjoy this benefit.

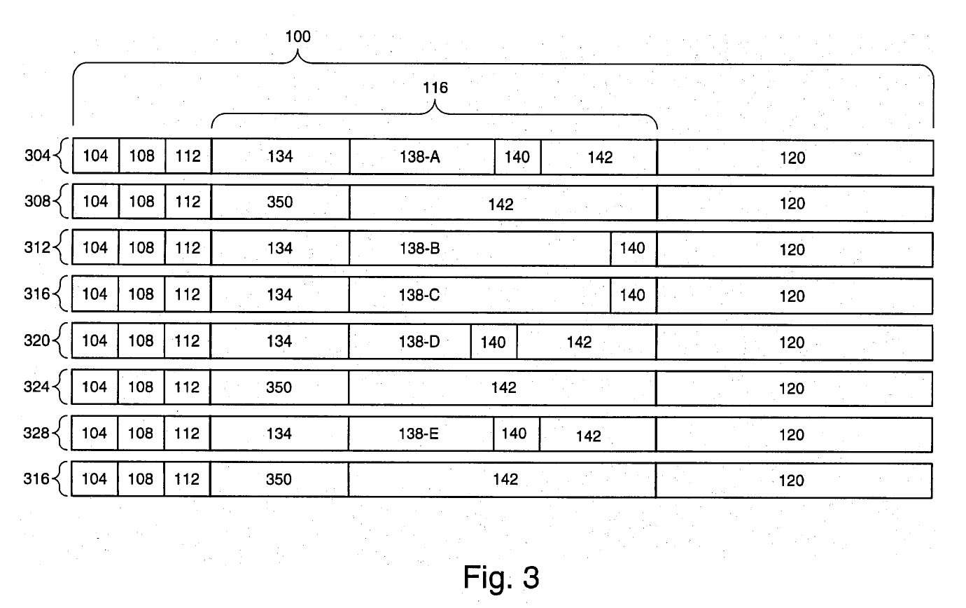

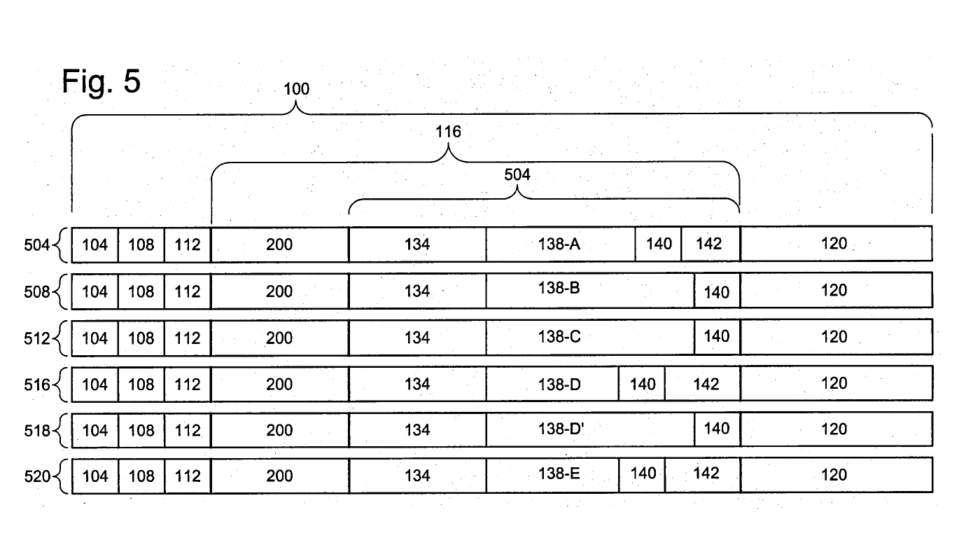

FIG. 5 shows the preferred alternative location for the USR Message 200 would be in a portion of the MPEG Frame Payload 116. The USR message could be placed in the front of the MPEG Frame payload with the rest of the MPEG Frame payload carrying Data Sub-packets 130. Effectively this would simply reduce the size of the frame payload by 8 bytes as the frame Payload 116, now a USR Message 200 and a shortened Payload 504. The downstream frame of FIG. 5 has the FEC Field 120 available for use in forward error correction. As shown by the use of an additional Frame 518 to carry the residual of 138-D in 138-D′, the reduction size of the effective payload for data sub-packets will increase the number of frames needed to carry a fixed amount of downstream data over FIG. 3 or FIG. 4. However, as FIG. 5 is able to send a polling request in each downstream frame and does not need to delay transmission of downstream data in order to send a frame with just a polling request. Thus, FIG. 5 represents an improvement over FIG. 3.

Alternatively, the USR message could also be placed in the last 8 bytes of the MPEG Frame Payload, but this is likely to require some additional overhead to calculate how much of the downstream Sub-packets could fit within the MPEG Frame Payload. Likewise, placing the USR message at some point between the beginning and the end of the MPEG Frame Payload is viewed as less desirable as this choice leads to either an increase in the amount of Frame Payload that goes unused or in making the process more resource intensive, or both.

The option of extending the MPEG/DVB frame by 8 bytes is less attractive in that mass produced components exist that operate on the standard length MPEG/DVB frame. Having a non-standard frame would preclude or complicate the use of these off-the-shelf components.

Whenever a modem decodes its polling address such as its unique MAC address in the USR Message 200, the client modem responds with an upstream transmission if the client modem has data to transmit. The complete upstream transmission is sent in one variable length Upstream Frame 150. After the Server 36 receives the upstream burst, a subsequent downstream Frame 100 can convey the next USR Message 200 to poll the next client modem.

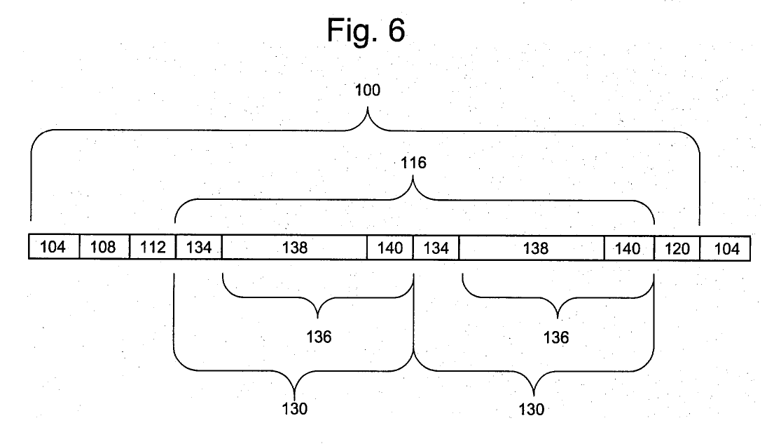

An alternative means for improving the efficiency of the downstream frames is shown in FIG. 6 where the Payload 116 contains more than one Data Sub-packet 130. In a preferred embodiment, the frames with more than one Data Sub-packet 130 would use a PID value in the PID Field 108 that would alert the downstream devices to check for a subsequent Sub-packet Header 134 at a fixed distance into the Frame Payload 116. This process is well-suited for conveyance of Data Sub-packets 130 that are short relative to the length of the frame Payload 116 and of fixed length so that the location of the subsequent sub-packet header could be conveyed by a status flag rather than a byte offset.

The frame of FIG. 6 could be used to convey two or more data sub-packets or a data sub-packet and a polling request if the polling request was not otherwise in the frame in one of the locations suggested above. While it would be possible to send more than one polling request in a given frame, this would require a scheme that provided offsets for the responses to the polling requests so as to avoid bus contention. An application for a method of group polling is currently pending for assignee coaXmedia with U.S. Ser. No. 10/205,523, Methods for Detecting and Polling Downstream Modems.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

Glossary of Abbreviations

Glossary of Abbreviations

| | |
|---|---|
| CRC | Cyclic Redundancy Check |
| DS | Downstream |
| DVB | Digital Video Broadcast |
| FEC | Forward Error Correction |
| MAC | Media Access Control (Modem/adapter physical address) |
| RS | Reed-Solomon (Forward error correction technique) |
| US | Upstream |
| USR | Upstream Request |

We claim:

1. A method of transmitting a polling request from an upstream device to a set of downstream devices, the polling request seeking a response from a single targeted downstream device, the method comprising:
a. Re-allocating a specific portion of downstream frames prepared in compliance with a Digital Video Broadcasting standard for use in conveying upstream message requests; the frames prepared in compliance with the Digital Video Broadcasting standard also containing a Sync indicator, and a frame payload containing at least one data sub-packet, each data sub-packet containing a sub-packet payload and the address of at least one downstream device targeted to receive the sub-packet payload;
b. Creating an upstream request message comprising an address field carrying an address identifier sufficient to uniquely identify a single targeted downstream device, this upstream request message containing an address for the single targeted downstream device targeted for polling;
c. Placing the upstream message request in the specific portion of a downstream frame reallocated for this use; and
d. Sending the downstream frame to the set of downstream devices to deliver:
i. the polling request to the downstream device targeted for polling; and
ii. the sub-packet payload to the downstream device targeted to receive the sub-packet payload.

2. The method of claim 1 wherein the specific portion of the downstream frames re-allocated for use in conveying upstream message requests is within the field originally allocated as a FEC field.

3. The method of claim 1 wherein the specific portion of the downstream frames re-allocated for use in conveying upstream message requests is immediately after the frame payload.

4. The method of claim 1 wherein the specific portion of the downstream frames re-allocated for use in conveying upstream message requests is within the field originally allocated for the frame payload.

5. The method of claim 4 wherein the specific portion of the downstream frames re-allocated for use in conveying upstream message requests is at the beginning of the field originally allocated for the frame payload.

6. The method of claim 1 wherein the specific portion of the downstream frames re-allocated for use in conveying upstream message requests is immediately after a continuity count field in the data frame.

7. A method of operating a device to receive a data frame with both data and upstream request channel communications, the method comprising:
A) Connecting the device to a shared medium having a downstream channel and an upstream channel;
B) Monitoring the downstream channel to detect the sync indicator marking the beginning of a new downstream frame;
C) Receiving data targeted to the device from within the data frame payload if a data address corresponding to the device is found in the header for the data;
D) Reading the polling address contained in the same data frame in a band of polling address data a fixed number of bytes after the sync indicator; and
E) Responding on the upstream channel if the polling address found in the band of polling address data matches a polling address associated with the device.

8. The method of claim 7 wherein the polling address data is in portion of the data frame corresponding normally used for a FEC field.

9. The method of claim 7 wherein the polling address data is in portion of the data frame immediately following the data frame payload.

10. The method of claim 7 wherein the polling address data is located immediately after the continuity count field in the data frame.

11. A method of sending at least one data sub-packet (comprising a data sub-packet header containing an address field, and a data sub-packet payload,) in a single data frame; the method comprising:
Creating a data frame comprising a sync indicator, packet identification field comprising at least one bit, and a frame payload;
IF the frame payload is of the first type,
THEN placing one data sub-packet in the frame payload; and
Placing an indicator of a single sub-packet payload in the packet identification field such that a first downstream device and a second downstream device will be able to read the indicator of a single sub-packet and look for a single data sub-packet header;
IF the frame payload is of a second type,
THEN placing a first sub-packet addressed to the first downstream device in the frame payload;
Placing a second sub-packet addressed to the second downstream device, different from the first downstream device, in the frame payload a fixed distance from the start of the frame payload; and
Placing an indicator for a two sub-packet payload in the packet identification field such that the both the first and the second downstream devices read the indicator of the two sub-packet payload and read the both sub-packet headers; and
Transmitting the data frame onto a communication channel connected to the first downstream device and the second downstream device.

12. The method of claim 11 wherein the frame payload is of the second type and the first sub-packet conveys data to be used by an application after being read by the first downstream device and the second sub-packet conveys data to be used by an application after being read by the second downstream device.

13. The method of claim 11 wherein the frame payload is of the second type and the first sub-packet conveys data to be used by an application after being read by the first downstream device and the second sub-packet conveys a polling request to the second downstream device.

14. The method of claim 11 wherein the frame payload is of the second type and the first sub-packet conveys a polling request to the first downstream device and the second sub-packet conveys data to be used by an application after being read by the second downstream device.

15. A method of sending at least one data sub-packet (comprising a data sub-packet header containing an address field, and a data sub-packet payload,) in a single data frame; the method comprising:
Creating a data frame comprising a sync indicator, packet identification field comprising at least one bit, and a frame payload;
IF the frame payload is of the first type,
THEN placing one data sub-packet in the frame payload; and
Placing an indicator of a single sub-packet payload in the packet identification field such that a first downstream device and a second downstream device, different from the first downstream device, will be able to read the indicator of a single sub-packet and look for a single data sub-packet header;
IF the frame payload is of a second type,
THEN placing a first sub-packet addressed to the first downstream device in the frame payload;
Placing a second sub-packet addressed to the first downstream device in the frame payload a fixed distance from the start of the frame payload; and
Placing an indicator for a two sub-packet payload in the packet identification field such that the both the first and the second downstream devices read the indicator of the two sub-packet payload and read the both sub-packet headers; and
Transmitting the data frame onto a communication channel connected to the first downstream device and the second downstream device.
